(19) United States
(12) Patent Application Publication
(10) Pub. No.: US 2008/0268952 A1
(43) Pub. Date: Oct. 30, 2008

(54) GAME APPARATUS AND METHOD FOR CONTROLLING GAME PLAYED BY MULTIPLE PLAYERS TO COMPETE AGAINST ONE ANOTHER

(75) Inventors: Daisaku Ikejiri, Tokyo (JP); Masashi Muramori, Kanagawa (JP); Yoshihiro Ueno, Kanagawa (JP); Kentarou Nakazawa, Kanagawa (JP)

Correspondence Address: KATTEN MUCHIN ROSENMAN LLP, 575 MADISON AVENUE, NEW YORK, NY, 10022-2585, US

(73) Assignee: Sony Computer Entertainment Inc., Tokyo (JP)

(21) Appl. No.: 12/104,620

(22) Filed: Apr. 17, 2008

(30) Foreign Application Priority Data
Apr. 24, 2007 (JP) JP2007-114893

(51) Int. Cl. A63F 13/00

(52) U.S. Cl. 463/31; 463/42

(57) ABSTRACT

A game control technique which is improved in convenience is provided. A game apparatus includes a control section which receives an instruction input from a player to control a character or an object, a data receive section which acquires information about a character or an object controlled by another player; and an image creation section which creates and displays a game image including the character or the object controlled by the player and the character or the object controlled by the other player. The position of the character or the object controlled by the other player may meet a predetermined condition that the player's progression through a game is interrupted by the character or the object controlled by the other player being displayed in the game image. A competitor display section then causes the character or the object controlled by the other player to be not displayed at all, or to be displayed with increased transparency.

### BACKGROUND OF THE INVENTION

1. Field of the Invention

The present invention relates to a game control technique, and in particular, to a game apparatus, a game control method, a game control program, and a management server, which provide the ability to control a game that is played by a plurality of players competing against one another.

2. Description of the Related Art

Currently, computer golf games where gamers play by controlling a particular character or characters are gaining popularity. Even in the real world, golf is a popular sport that is played by many people of all ages.

For a plurality of players to play a game of golf at the same time, the players must each hit a ball one by one, taking turns, just as they do in the real world, thus requiring much more time when compared with one player playing the game alone. Furthermore, the larger the number of players playing a game at the same time, the longer the waiting time between hits becomes. This may cause players to be discouraged from maintaining their interest in the game.

### SUMMARY OF THE INVENTION

The present invention has been developed in view of these problems. It is therefore a general purpose of the invention to provide a game control technique which can improve the quality of the entertainment provided.

One embodiment of the present invention relates to a game control program product. The game control program product implements, on a computer, a controlling function which receives an input instruction from a player to control a character or an object; a generating and displaying function which generates and displays a game image which includes the character or object; an acquiring function which acquires information about a character or an object being controlled by another player; and a displaying function which displays the character or object being controlled by the other player on the game image. The game control program is characterized in that when the position of the character or object being controlled by the other player meets a predetermined condition such that the player's progression through a game is interrupted by the character or object controlled by the other player being displayed on the game image, the displaying function causes the character or object being controlled by the other player to be not displayed at all, or to be displayed in a translucent manner.

Another embodiment of the present invention relates to a management server. The management server includes: a participant registration section which registers a plurality of game apparatuses running a game and participating in a tournament in which the game apparatuses play the game in parallel in order to compete against one another; a data receive section which receives, from a game apparatus participating in the tournament, information that is indicative of a position of a character or an object in the game that is being played by the game apparatus; and a data transmit section which transmits the information received from the game apparatus to another game apparatus that meets a predetermined condition from among the plurality of game apparatuses participating in the same tournament.

Arbitrary combinations of the aforementioned constituting elements, and any implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a view illustrating the configuration of a game system according to an embodiment;

FIG. 2 is a view illustrating the internal configuration of a management server;

FIG. 3 is a view illustrating an example of data in a management table;

FIG. 4 is a view illustrating the configuration of a game apparatus;

FIG. 5 is a view illustrating an example of a game image in which a player's character hits a ball;

FIGS. 6A and 6B are views illustrating an example of a game image in which a player's character is making a backswing motion;

FIGS. 7A and 7B are views illustrating an example of a game image in which a player's character is making a backswing motion;

FIGS. 8A and 8B are views illustrating an example of a game image in which a player's character is making a downswing motion;

FIG. 9 is a view illustrating an example of a game image in which a competitor's character and ball are displayed;

FIG. 10 is an explanatory view illustrating how a decision is made as to whether or not to display a competitor's character and ball; and

FIG. 11 is a view illustrating an example of a score display image which is displayed upon completion of a hole.

### DETAILED DESCRIPTION OF THE INVENTION

The invention will now be described by reference to the preferred embodiments. This does not intend to limit the scope of the present invention, but to exemplify the invention.

A game system according to an embodiment provides a game in which a plurality of players compete against one another in real time. By way of example, this embodiment will be explained with reference to the game of golf.

In general, when a plurality of players play golf, each player hits their ball from a tee in turn in decreasing order of their scores obtained from the previous hole. Each player then hits their ball for the second and subsequent times in decreasing order based on the distance from their ball to the cup. This type of computer games in which a plurality of players each hit their ball in turn, just as in a real-world golf competition, may allow the gamers to feel as if they are competing against one another on a real golf course. However, each player has to wait for a considerable period of time until the other players have finished hitting their balls. This would require a longer time for the game to be played when compared with a game played by one player only.

In the present embodiment, each player is allowed to hit his ball just as if he/she were playing the game alone, irrespective of whether another player or players were also playing. This embodiment also allows a player to check how another player is playing the game, for example, by displaying in a game image the character controlled by the other player or the path of the ball struck by the other player. This allows each player to proceed through the game independently, thereby shortening the time required to play the game without any loss of feeling that the player is competing against another player in real time. It is also possible to provide a novel feeling that could never be experienced in a real-world golf competition, for example, in that a plurality of players can be playing on the same course at the same time and a player may hit his/her ball while a ball struck by another player that is flying through the air is being displayed.

Furthermore, since a player can check another player's shot in the game image, the player can hits his/her ball while checking another player's strategy. For example, when another player's ball lies near the player's ball on a green, the player can wait until the other player putts his/her ball, and then putts after having checked the path of the other player's ball. Conversely, the player can also putt first to put pressure on the other player. It is possible to undertake such a strategy irrespective of the order of putting determined by the distance from the cup rule.

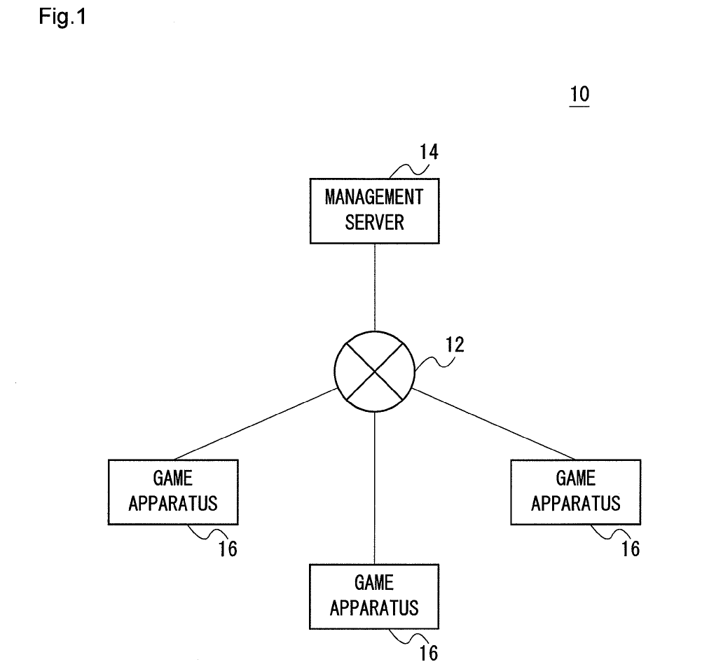

FIG. 1 illustrates the configuration of a game system 10 according to one embodiment of the present invention. The game system 10 includes a plurality of game apparatuses 16, and a management server 14 which manages a tournament in which those players utilizing the plurality of game apparatuses 16 participate in order to compete against one another. The plurality of game apparatuses 16 and the management server 14 are connected to each other via the Internet 12 or an example of networks. Each game apparatus 16 transmits information that is indicative of the status of a game being played on its own device to the management server 14. The game apparatus 16 also receives information indicative of the status of a game being played on another game apparatus 16 from the management server 14 and then displays, in the game image of its own device in real time, the status of the game being played on the other game apparatus 16.

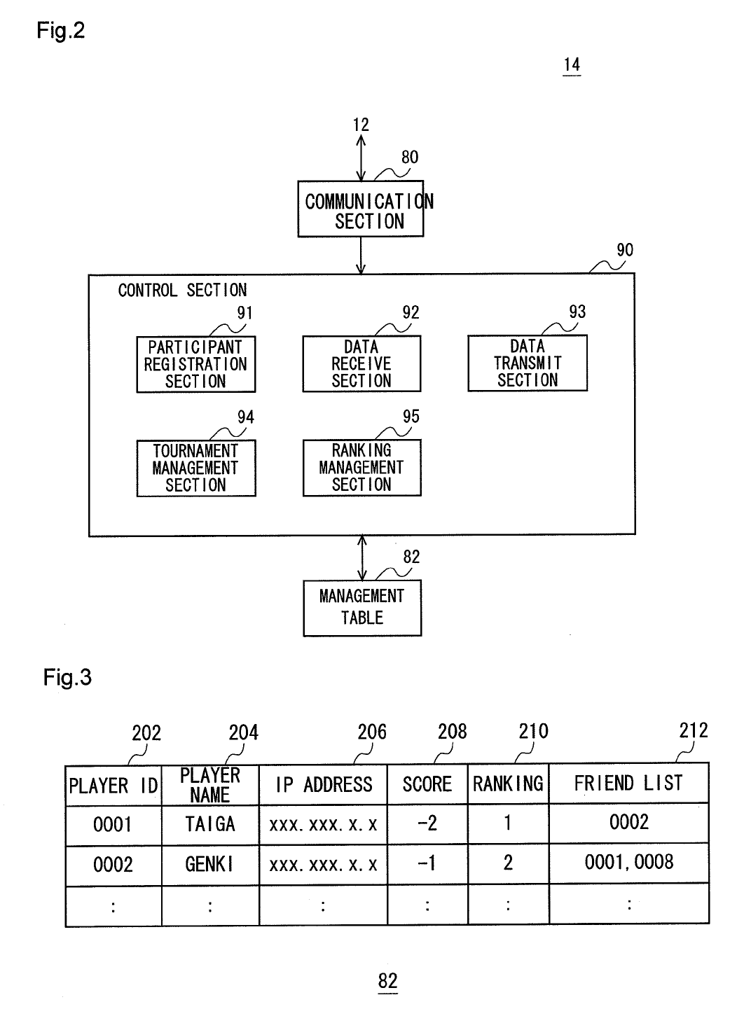

FIG. 2 illustrates the internal configuration of the management server 14. The management server 14 includes a communication section 80, a control section 90, and a management table 82. In terms of hardware components, these components may be implemented using the CPU of any computer, memory, or a program loaded in a memory device. The figure shows a functional block that is implemented by any combination of those components. It will be thus understood by those skilled in the art that these functional blocks may be implemented in various forms such as by hardware only, by software only, or by a combination thereof.

The communication section 80 controls communications with the game apparatuses 16 via the Internet 12. The management table 82 stores data required to manage a tournament in which a plurality of game apparatuses 16 participate in order to compete against one another.

FIG. 3 shows an example of data in the management table 82. The management table 82 is provided with a player ID column 202, a player name column 204, an IP address column 206, a score column 208, a ranking column 210, and a friend list column 212. The player ID column 202 stores the ID of a player participating in a tournament. The player name column 204 stores the name of the player. The IP address column 206 stores an IP address assigned to the game apparatus 16 of the player. The score column 208 stores the score of the player. The ranking column 210 stores the ranking of the player. The friend list column 212 stores a list of IDs of other players whom the player has registered to chat with or to be informed of each others respective game status. For the management server 14 to manage a plurality of tournaments at the same time, multiple management tables 82 are provided.

The control section 90 includes a participant registration section 91, a data receive section 92, a data transmit section 93, a tournament management section 94, and a ranking management section 95. The participant registration section 91 registers a plurality of game apparatuses 16 that are running a game and that are participating in a tournament where the game apparatuses are playing the game in parallel in order to compete against one another. The participant registration section 91 may use a web page or the like to register the game apparatuses 16 that are going to participate in a tournament. In this case, the management server 14 is configured to function as a web server. Upon registration of a game apparatus 16 that is going to participate in a tournament, the participant registration section 91 acquires the player ID, the player name, the friend list of the player of the game apparatus 16, and the IP address of the game apparatus 16 to be registered with the management table 82. Information about players may be pre-stored in a user database (not shown) or the like. In the present case, the participant registration section 91 may use the player ID to retrieve information stored in the user database, thereby acquiring information associated with the player name and the friend list or the like.

The data receive section 92 receives, from a game apparatus 16 that has participated in a tournament, information indicative of the position of a character or an object in a game that is being played by the game apparatus 16. The data receive section 92 receives data which each game apparatus 16 needs in order to display, in the game image of its own device, the character or object of the game being played by another game apparatus 16. In the present embodiment, the eight game image frames of information detailed below are received from each game apparatus 16.

The absolute coordinates of the position of a ball in the game world (being the first frame).

The absolute coordinates of the position of a character in the game world (in the first frame this will be only X and Z).

The difference in the position of a ball between the current and previous frames (in the second and subsequent frames this will be seven frames in total).

The difference in the position of a character between the current and previous frames (in the second and subsequent frames this will be seven frames in total, but with only X and Z).

The motion number which indicates the motion of a character (for example, Hitting: 1, Putting: 2, and Scattering lawn for determining a wind direction: 3).

The character motion frame number or the ordinal number of the frame which indicates, for example, a hitting, putting, or lawn scattering motion.

The angle in which a character is oriented.

The flag of information on a character: the type of a club owned by the character (Wood, Iron, Putter), or whether a left-handed swing is taken (perhaps because a ball cannot be addressed with a right-handed swing due to an obstacle such as a tree). The information, such as the type of club set or the costume of a character, which is not changed during the play on a course, is transmitted only once at the start of the course.

The flag indicative of the status of a character: for example, during a stand-by state before a ball is hit, during a swing, during the flight of a ball, during a stationary condition of a ball, during a triumphant pose being struck upon completion of a hole, and during viewing a score card after a hole has been completed.

The data receive section 92 may record these pieces of information on the management table 82.

The data transmit section 93 transmits the information received from the game apparatus 16 to a game apparatus 16 that meets a predetermined condition from among the plurality of game apparatuses 16 participating in the same tournament.

The tournament management section 94 manages the progress of a tournament. In the present embodiment, in order to progress through a tournament quickly, there is a time limit provided for each hole so that a player who cannot complete the hole within the allocated time limit will be disqualified. The management server 14 may manage the time limit. However, in the present embodiment, each game apparatus 16 manages the time limit in order to inform the management server 14 that a player was not able to complete the hole within the allocated time limit. Upon receipt of the notice of a disqualified player, the tournament management section 94 stores “−1”, which indicates that the relevant player was disqualified, in the ranking column 210 of the management table 82 associated with that player. The data transmit section 93 does not transmit the information on the other game apparatuses 16 to the game apparatus 16 of the disqualified player. The tournament management section 94 may give a benefit to a player who completed a hole earlier than the other players, for example, a bonus point or a capability of hitting a ball with a special effect.

The ranking management section 95 manages the ranking of the players participating in the tournament. The ranking management section 95 acquires from each game apparatus 16 the score for each hole for the players who completed the hole, and then updates the score column 208 of the management table 82 as well as computing the ranking based on the score to update the ranking column 210.

The data transmit section 93 may transmit, to each game apparatus 16, the information received from the game apparatuses 16 of a predetermined number of higher ranking players selected from among those participating in the tournament. This allows each player to progress through a game while checking the play of higher ranking players. The data transmit section 93 may extract a predetermined number of players having a ranking close to that of a data receiving game apparatus 16, and then transmit the information received from the game apparatus 16 of an extracted player to the receiving game apparatus 16. This allows each player to progress through a game while checking on the screen the play of a player having a ranking close to his/her own. The data transmit section 93 may also transmit the information received from the game apparatus 16 of a gamer that the player of a data receiving game apparatus 16 has registered on his/her friend list. As described above, even in the case of a large number of players participating in a tournament, an appropriate number of players are extracted in order to transmit information that is indicative of the status of the game being played by the extracted players. It is thus possible to display the status of the other game apparatuses 16 without improperly increasing the processing load of each game apparatus 16.

Upon receipt of information from a game apparatus 16, the data transmit section 93 may immediately transmit the information to another game apparatus 16. Alternatively, the data transmit section 93 may collect information from all the game apparatuses 16 whose information is to be transmitted to the other game apparatus 16 and then transmit the pieces of information thereto at a time.

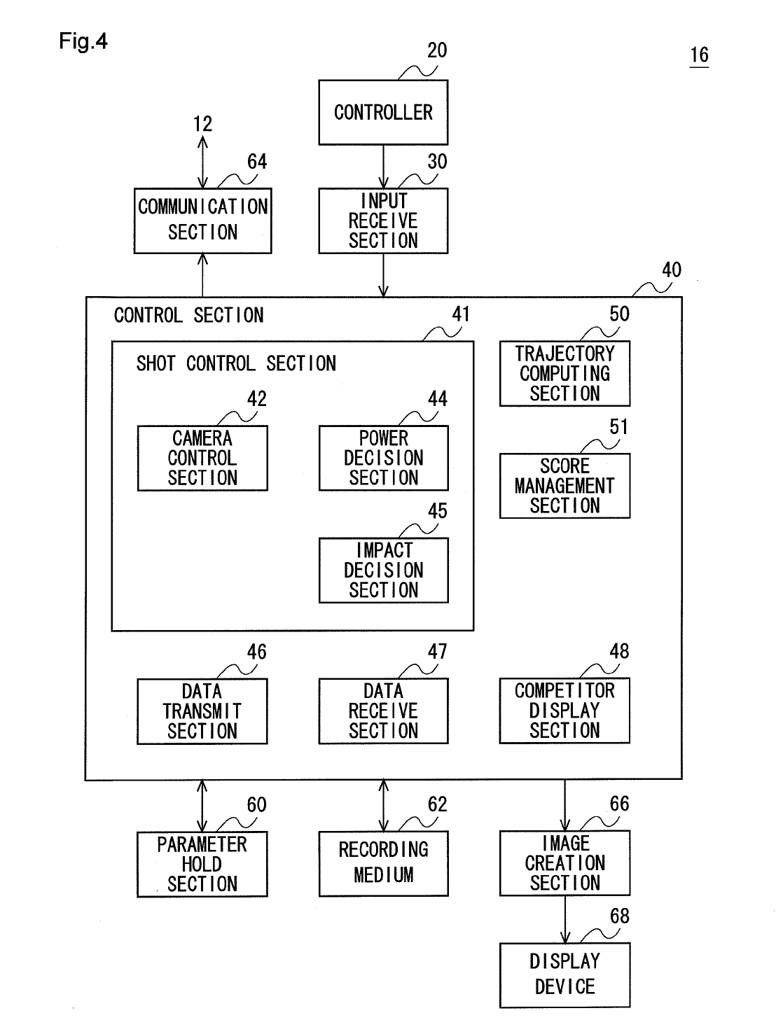

FIG. 4 shows the configuration of the game apparatus 16. The game apparatus 16 includes a controller 20, an input receive section 30, a control section 40, a parameter hold section 60, a recording medium 62, a communication section 64, an image creation section 66, and a display device 68. This configuration may be implemented in various forms such as by hardware only, by software only, or by a combination thereof.

The communication section 64 controls communications with the management server 14 via the Internet 12. The input receive section 30 receives a control signal supplied from the controller 20 being controlled by a player. The control section 40 reads and executes a golf game program stored in the recording medium 62. Based on a control input provided by a player and received by the input receive section 30, the control section 40 allows the golf game to progress while controlling the motion of a player's character that acts as a golf player in the game world. The parameter hold section 60 holds those parameters which are required in order to progress through a golf game. The image creation section 66 creates an image for a game which is controlled by the control section 40 and allows the display device 68 to display the image.

The shot control section 41 controls shots taken by the player's characters. The shot control section 41 includes a camera control section 42, a power decision section 44, and an impact decision section 45.

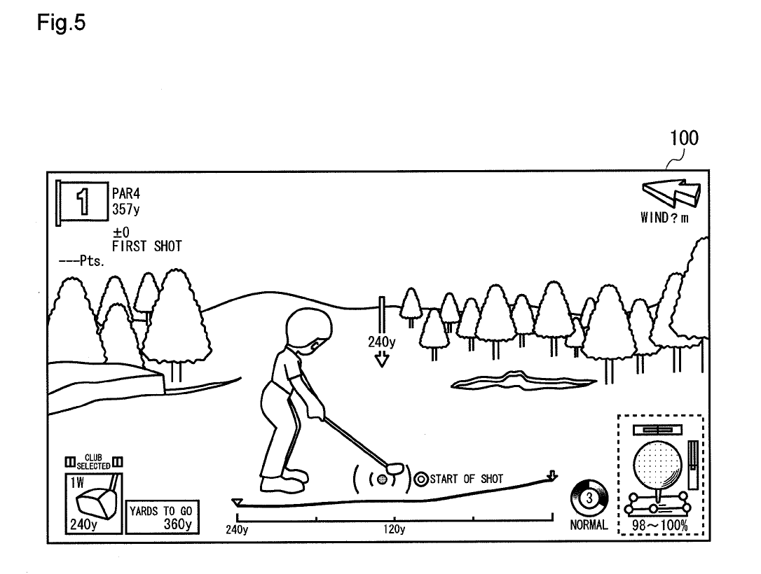

FIG. 5 shows an example of a game image appearing when a player's character hits a ball.

In a game image 100, an image is rendered in order to show the geographical features of a course where the player's character is playing, and an image viewed behind the player's character is also displayed. In this image, the player manipulates the controller 20 to determine the power and impact of the shot, and then allows the player's character to hit the ball.

The camera control section 42 controls the view point position and line of sight of a camera when the image creation section 66 creates a game image. In order to create a game image that appears when the player's character hits a ball, the camera control section 42 provides initial settings such that the view point is located behind the player's character and the line of sight is set to look at the player's character. The player can change the view point position and the line of sight by manipulating the controller 20 in order to check the geographical features of the hole or determine the direction and distance of the shot. As will be described later, the camera control section 42 changes the view point position and the line of sight of the camera according to a control input from the player, and then informs the image creation section 66 of the changes.

The power decision section 44 determines the power of the shot taken by the player's character. When a control input assigned an instruction to start a shot is received from the controller 20, the power decision section 44 causes the image creation section 66 to create an image for displaying the player's character making a backswing motion in order to hit the ball, and then causes the display device 68 to display the image. The player manipulates the controller 20 in order to provide a control input that is assigned an instruction to determine the power of the shot, with the degree of the progression of the backswing motion made by the player's character being employed as a measure. The power decision section 44 determines the power of the shot according to the degree of progression of the motion made by the player's character for the shot at the point in time at which the control input used to determine the power was received. The power decision section 44 informs a trajectory computing section 50 of the determined power.

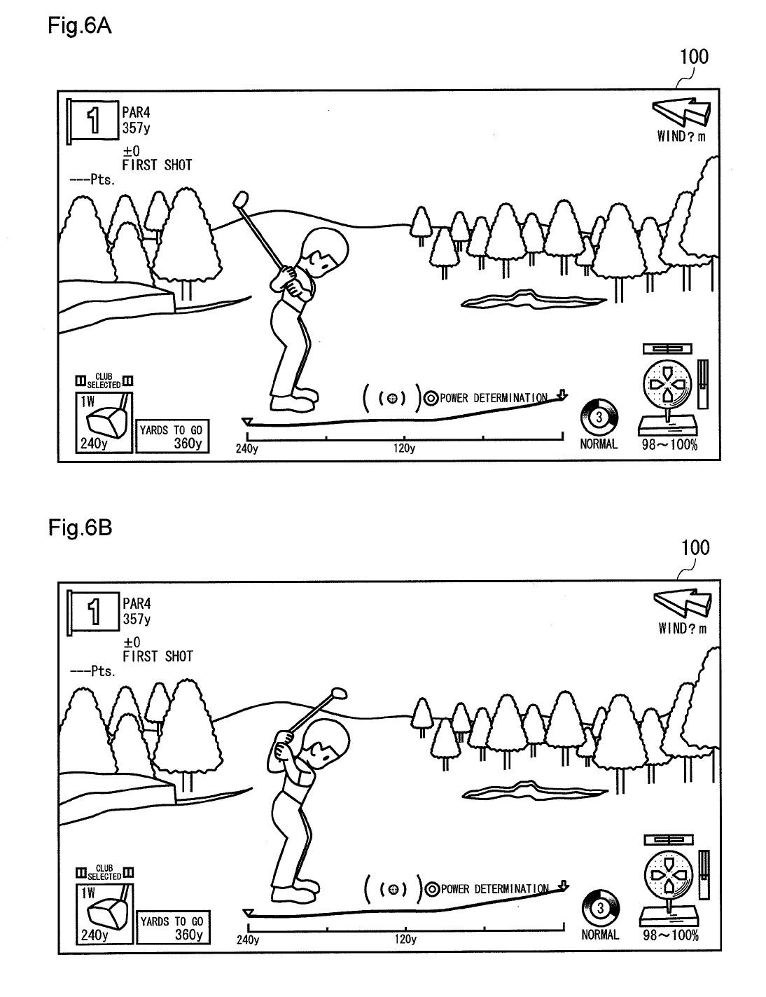

FIGS. 6A and 6B show examples of a game image that appears when the player's character is making a backswing motion. FIG. 6A shows that the player's character has started a backswing motion and half of the time required to reach a full swing motion has elapsed. Upon receipt of a control input from the player at this point in time, the power decision section 44 determines that the power of the shot is 50%. FIG. 6B shows that the swing by the player's character has reached the top of the swing arc. Upon receipt of a control input from the player at this point in time, the power decision section 44 determines that the power of the shot is 100%. When the top of the swing arc was reached without receiving a control input during a backswing motion, the power decision section 44 may also determine that the swing was just a practice swing, so that no shot is made.

When a game image in which the player's character hits the ball is displayed, the camera control section 42 instructs the image creation section 66 to change the view point position or the line of sight used for creating an image according to an input instruction from the player. For example, depending on the geographical features or the condition of an obstacle around the ball, the backswing motion of the player's character may be difficult to view. In this case, the player may not be able to easily determine when to provide the control input for determining the power to be used. Thus, the camera control section 42 changes the view point position or the line of sight of the camera, so that the backswing motion of the player's character can be easily viewed.

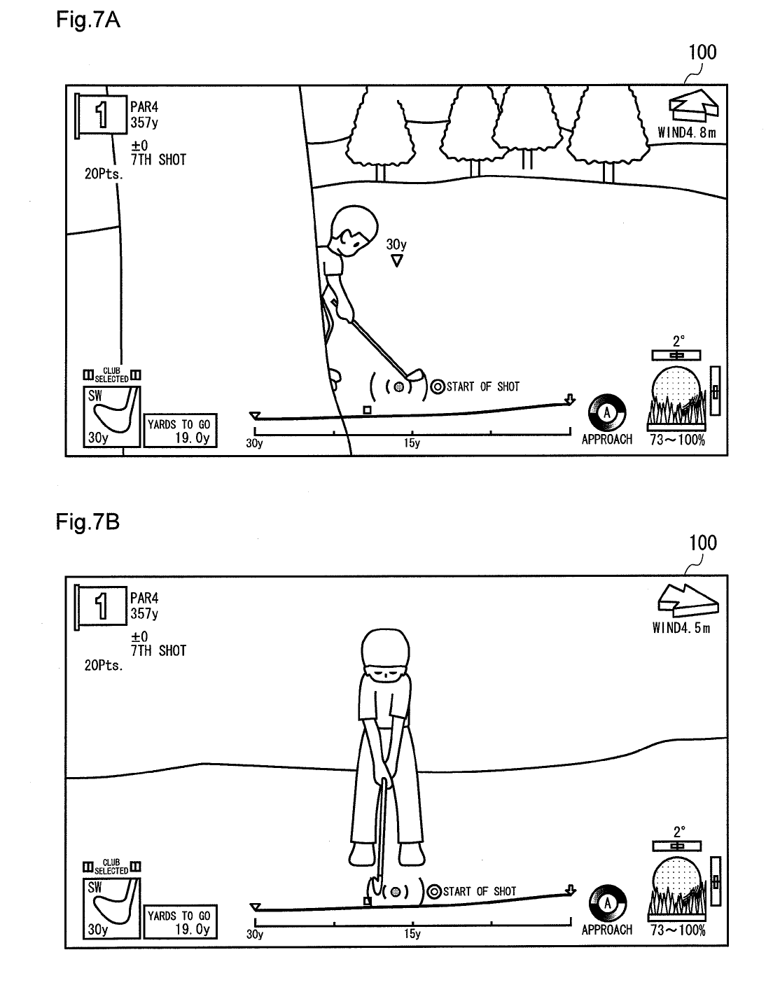

FIGS. 7A and 7B show an example of a game image that appears when the player's character is making a backswing motion. As shown in FIG. 7A, the backswing motion of the player's character may not be seen well in an image used for viewing the character from behind because of an obstacle such as a tree obstructing the player's view. In this case, by using an arrow key on the controller 20, the player provides a control input to change the view point position or the line of sight of the camera. As shown in FIG. 7B, according to the control input from the player, the camera control section 42 changes the view point position or the line of sight of the camera so that the image can provide a clear view of the backswing motion of the player's character. As is also shown in FIG. 7B, setting the view point position at one side of the player's character facilitates the viewing of the degree of progression of a backswing motion being made by the player's character, thus implementing a user interface with improved controllability.

The camera control section 42 may automatically move the view point position of the camera to a position at which the backswing motion of the player's character can be easily viewed. In particular, when the player's character is putting, a slight backswing motion may be made so that the move of the putter cannot be recognized well when viewed from behind the player's character. Thus, the camera control section 42 may change the view point position of the camera to one side of the player's character.

The impact decision section 45 determines the impact of the shot taken by the player's character. After the power decision section 44 has determined the power of the shot, the impact decision section 45 causes the image creation section 66 to create an image in which the player's character is making a downswing motion, and causes the display device 68 to display the image. With respect to the timing at which the player's character makes a downswing motion in order to strike the ball, the player uses the controller 20 to provide a control input to which an instruction to determine the impact is assigned. The impact decision section 45 determines the impact of the shot according to the time difference between the point in time at which the player's character made a downswing motion to strike the ball and the point in time at which the control input to determine the impact was received. The impact decision section 45 informs the trajectory computing section 50 of the determined impact. In the present case, the control input that is received earlier than the instant at which the impact becomes 100% may be denoted with a minus sign and the control input that is received after that instant may be denoted with a plus sign, thereby expressing whether the timing of the control input was late or early.

As an aid to a measure for adjusting the timing, the impact decision section 45 causes the image creation section 66 to create an image which includes a graphical object and causes the display device 68 to display the image. In this instance, the graphical object contracts with time and becomes smallest at the point in time at which the player's character strikes the ball, i.e., at the point in time at which the ball can be struck with the highest impact. The player can also employ the contracting graphical object as an additional measure to provide to the control input in order to determine the impact of the shot. The impact decision section 45 may also display a graphical object having the position of the ball at its center or at its center of gravity, thereby allowing the object to contract to the position of the ball as if it converges thereto. This allows the player to provide control while checking both the player's character making a downswing motion and the contraction of the graphical object, thus implementing a user interface with improved controllability.

By way of example, the impact decision section 45 may determine the impact as follows. That is, the impact at the point in time at which the player's character strikes the ball, i.e., at the point in time at which the time difference is zero, may be defined as a 100% impact. The impact at the point in time at which the time difference is at a predetermined upper limit may be defined as a predetermined lower limit impact. Then, the impact at the point in time at which the control input was received may be determined by proportionally dividing the range between the 100% impact and the lower limit impact. As will be described later, the trajectory computing section 50 corrects the distance of flight or the direction of a ball in a manner such that the lower the value of the impact determined by the impact decision section 45, the greater the deviation from the target landing point of the ball becomes. The time difference may exceed the predetermined upper limit without receiving a control input after the player's character makes a downswing motion past the ball. In this case, the impact decision section 45 may determine that the swing was just a practice swing, so that no shot is made, or alternatively, may automatically set the impact to a predetermined lower limit to make a shot.

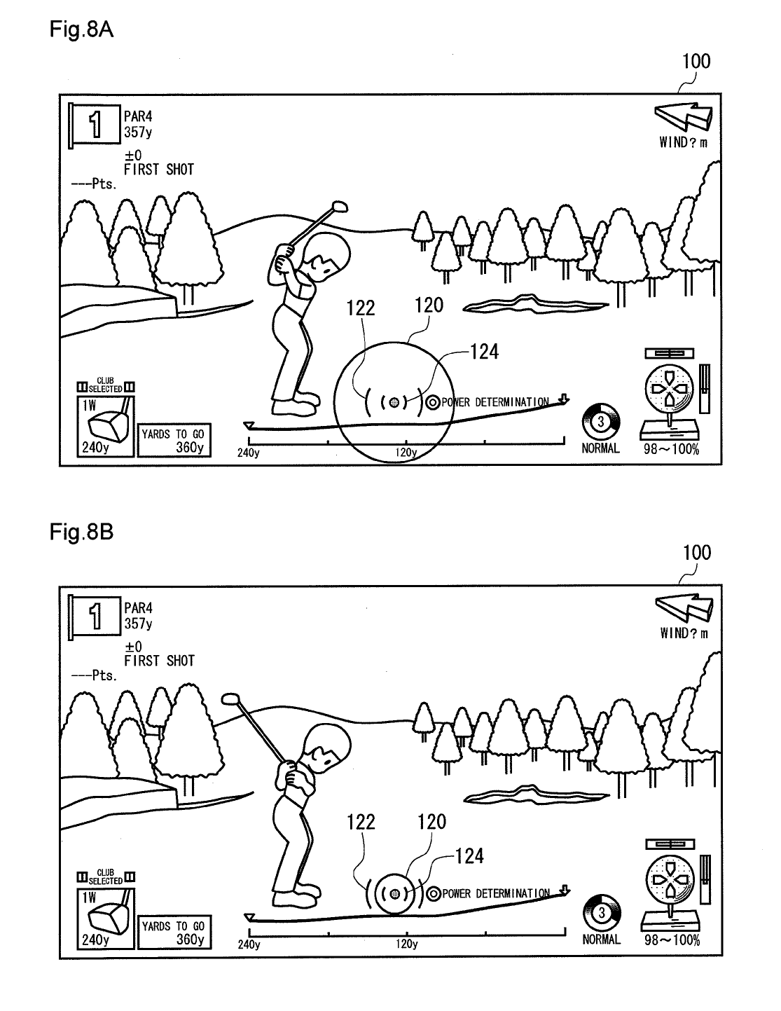

FIGS. 8A and 8B show examples of a game image that appears when the player's character is making a downswing motion. FIG. 8A shows that the player's character has started a backswing motion. The impact decision section 45 displays a circle 120 as an aid to a measure for adjusting the timing. Furthermore, the impact decision section 45 also displays a graphical object 122 which indicates the diameter taken by the circle 120 when the impact is at a lower limit, and a graphical object 124 which indicates the diameter taken by the circle 120 when the impact is at an upper limit, for example, 100%. When a control input is received with the diameter of the circle 120 being greater than the diameter indicated by the graphical object 122, the impact decision section 45 may set the impact to a predetermined lower limit. Furthermore, in this case, as will be described later, the trajectory computing section 50 may consider this shot as a mishit. When a control input is received with the diameter of the circle 120 being less than the diameter indicated by the graphical object 124, the impact decision section 45 may set the impact to a predetermined upper limit, for example, 100%. A control input may be received when the diameter of the circle 120 is less than the diameter indicated by the graphical object 122 and greater than the diameter indicated by the graphical object 124. In this case, the impact decision section 45 may set a value between the predetermined upper limit and the lower limit in accordance with the timing at which the control input is received. FIG. 8B shows that the player's character is about to strike the ball. The impact decision section 45 contracts the circle 120 to its minimum size at the instant at which the player's character strikes the ball. If no control input has been received until the instant at which the player's character strikes the ball, then the impact decision section 45 may expand the circle 120 from then on. In this case, the impact may also be set at the upper limit while the diameter of the circle 120 is less than the diameter indicated by the graphical object 124. Conversely, when the diameter of the circle 120 is greater than the diameter indicated by the graphical object 122, the impact may be set at the lower limit. No control input may be received even at the point in time at which the circle 120 is greater than the diameter indicated by the graphical object 122. In this case, the impact may be automatically set to the lower limit to hit the ball. As another example, the impact decision section 45 may also define a lower limit for the impact when the diameter of the circle 120 is greater than the diameter indicated by the graphical object 122. The impact decision section 45 may allow the impact to be increased as the diameter is reduced, so that an upper limit is defined for the impact when the diameter of the circle 120 is the same as the diameter indicated by the graphical object 124. From then on, the impact may be gradually reduced as the diameter of the circle 120 becomes less than the diameter indicated by the graphical object 124.

As yet another example, the impact decision section 45 may employ a gauge to be displayed as a measure for adjusting the timing at which the player provides a control input. In this instance, the gauge indicates the position of a graphical object which moves with time horizontally, vertically, or along a given straight line or curved line. The gauge also indicates the position of a graphical object which shows the maximum impact. Furthermore, the impact decision section 45 may determine the impact and power of a shot depending on the angle, speed, and pressure at which the analog stick on the controller 20 is manipulated. The trajectory computing section 50 physically computes the trajectory of a struck ball based on the power and impact of the shot determined by the shot control section 41, the lie of a ball, and external factors such as wind or geographical features.

The trajectory computing section 50 reads from the parameter hold section 60 the initial velocity and the loft angle which were pre-defined for the club used for the shot. After having read the initial velocity, the trajectory computing section 50 adjusts the initial velocity or the loft angle in accordance with the power determined by the power decision section 44, the impact determined by the impact decision section 45, an attribute value such as a physical strength set for each player's character, and the lie of the ball. For example, the initial velocity may be multiplied by the percent value of the power and the impact so that a higher power or impact may cause a greater initial velocity. Furthermore, the flight direction or the speed of the ball may be adjusted so that a smaller value of the impact will cause the ball to be further deviated from the target landing point. For example, the orbit of the ball may be curved rightward as a slice ball when a control input was received earlier than the point where the impact becomes 100%, whereas the ball may be curved leftward as a hook ball when the input was received after the point where the impact becomes 100%. Furthermore, when the impact is less than or equal to the predetermined lower limit, the shot may be regarded as a mishit, so that the trajectory is computed with an extremely low initial velocity. For a ball in the rough or in a bunker, the initial velocity may be defined so as to be lower than that in the fairway. Furthermore, a lower initial velocity may be defined for a ball when it contacts with more steeply inclined ground. When the player provides a control input to change the initial velocity or loft angle during a shot, the initial velocity or loft angle may be further adjusted by taking the influence of the change into account.

Once the initial velocity and loft angle are determined, the trajectory computing section 50 computes the position of the ball for each frame while adjusting the speed of the ball depending on the force acting thereon. The trajectory computing section 50 adds the velocity of the ball to that of the ball on the coordinates of its current position frame by frame in order to compute the coordinates of the position of the ball in the subsequent frame. The acceleration of gravity, lift, wind force, and air resistance are added to the velocity of the ball frame by frame. According to a physical law, the acceleration of gravity of 9.8 m/sec/sec is exerted on the ball in a downward direction. The lift is exerted on the ball in an upward direction in proportion to its velocity. The wind force may be made constant in direction and magnitude at any point in the course or may be varied depending on the location. The air resistance is exerted in a direction that is opposite to the direction of the travel of ball and takes on a value proportional to its speed. In this manner, the trajectory of the ball is computed in consideration of the direction and velocity of the wind, thereby demonstrating the difficulty with which the ball is hit while taking the effects of wind into account just as can be experienced when playing golf in the real world. It is thus possible to realize a more realistic golf game.

When the ball collides with something, its horizontal and vertical velocities are adjusted using those friction coefficients and restitution coefficients which are predefined for the attribute of each surface with which the ball collides. The friction coefficient and the restitution coefficient may be defined to have different values depending on the fairway, rough, or bunker, collided with. Furthermore, as a demonstrative effect, the trajectory computing section 50 may compute the trajectory in a special manner regardless of the physical law. This may provide variation to a golf game, thereby making the game more fun.

A score management section 51 manages the score of a player's character. When the player's character completes a hole, the score management section 51 records the score of the hole in the parameter hold section 60. Furthermore, the score management section 51 displays a score board until the player's character starts the tee shot for the next hole after having completed the current hole. As described above, in the present embodiment, each hole is provided with a time limit. Thus, the score management section 51 uses a timer to measure the time that elapses from the start of the play of a hole and displays the remaining time in the image. When the player cannot complete the hole within the time limit, the score management section 51 terminates the game, and then informs the management server 14 of the termination.

A data transmit section 46 creates and transmits transmitted data to the management server 14 in order to inform another game apparatus 16 of the status of the game on the own device. As described above, the transmitted data includes, for example, information indicative of the position of a character and the position of a ball. The data transmit section 46 transmits eight game image frames of data at a time to the management server 14 every eight frames.

A data receive section 47 receives information about the status of another game apparatus 16 from the management server 14 and then stores the information in the parameter hold section 60.

Based on the information received by the data receive section 47, a competitor display section 48 displays, in the game image of the own device, the status of the game apparatus 16 of a competitor. The competitor display section 48 displays the character or object being controlled by another player in the game image.

The position of the character or object being controlled by another player may meet a predetermined condition such that the player's progression through a game is interrupted by the character or object controlled by another player being displayed in a game image. In this case, the competitor display section 48 allows the character or object being controlled by another player to be not displayed at all. This predetermined condition may include at least one of the following conditions regarding where the character or ball of another player is located: within a predetermined range from the view point position of a camera at which a game image is created; within a predetermined range from the character or ball being controlled by the player; in between the view point position of the camera and the character or ball; within a predetermined range from a target position to which the player is trying to move the character or from a target position to which the player is trying to hit the ball; in between the target position and the character or ball; and in a direction in which the character or ball moves. In such a case, the competitor's character or ball may overlap the character or ball of the own device, stay in the direction of the shot or the cup, or overlap a moving image serving as a measure for determining the power or impact or another measure, thereby likely interrupting the player's control. For this reason, the competitor's character and ball are not displayed at all. In such a case, the competitor display section 48 may also increase the transparency of the competitor's character and ball so that they are translucent when displayed. The competitor display section 48 may make the competitor's character and ball able to be displayed in a translucent manner when they do not meet the aforementioned condition. In this case, the character and ball which meet the aforementioned condition may be further increased in transparency, thereby becoming more transparent when being displayed.

The competitor display section 48 may wait until the data receive section 47 acquires a predetermined number of game image frames of information, for example, 24 frames of information, and then display the character or ball being controlled by another player in a game image. As described above, the data receive section 47 receives 8 frames of data from the management server 14 every 8 frames; however, a delay may occur depending on the state of communications. When the received 8 frames of data are displayed and the next data cannot be received due to a delay, the image may become still, resulting in an undesired lack of motion. Accordingly, the competitor display section 48 waits until 24 frames of data are accumulated, and then reflects them in the display. As such, when the next data is received while 24 frames of data are being displayed, the character and ball of another player can be smoothly displayed without interrupting their motion. An actual delay in communication may cause a decrease in the remaining amount of data. Even in this case, when an image is changed for switching a view point position or at the time a hole is completed, it may be acceptable to wait until 24 frames of data are accumulated. There are shooting games or fighting games in which the players have to progress through the game while checking the status of a competitor in real time. Unlike these games, players playing golf or bowling games can proceed through the games by themselves without checking the status of a competitor. In the latter games, the status of a competitor does not need to be displayed strictly in real time. It is thus possible to accumulate and then display an approximate amount of data corresponding to an expected period of delay time, thereby providing a smooth display of motion.

Note that the shot control section 41 and the trajectory computing section 50 control the motion or movement of a character and ball irrespective of the character and ball being controlled by another player. As described above, a golf game or bowling game allows a player to progress through it by himself/herself irrespective of the status of a competitor. Thus, the shot control section 41 receives a player's control over a shot by the player's character irrespective of the status of a competitor. Furthermore, even when the competitor's character or ball is present in a trajectory, the trajectory computing section 50 does not make a collision decision but rather computes the trajectory as if the character or ball is not present therein. This allows a player to progress through the game irrespective of a competitor even though the status of the competitor is being displayed. It is thus possible to eliminate the time required to wait for a shot to be completed, thereby allowing the player to proceed quickly through the game. It is also possible to simplify the calculation of trajectories, thereby reducing the processing load.

Depending on the position of a ball computed by the trajectory computing section 50, the image creation section 66 sets the view point position of the camera and the line of sight so that the ball is included in the image. Then, the image creation section 66 creates an image which indicates a ball in flight, and displays the image on the display device 68. At this time, the competitor's character and ball located by the competitor display section 48 in the game world are also rendered for display.

The competitor display section 48 informs the image creation section 66 of the following information in order to locate a character in the game world. The information includes the coordinates that are indicative of the position of a competitor's character which does not meet the condition for no display, the angle at which the character is oriented, the type of a club owned, and information as to whether a left-handed swing is being made. Furthermore, when a character is making a motion, the competitor display section 48 informs the image creation section 66 of the motion number and the number of motion frames of the motion. Moreover, the competitor display section 48 informs the image creation section 66 of the coordinates which indicate the position of a competitor's ball. Based on data on the type and costume of a character, the image creation section 66 acquires shape data for the character from the recording medium 62 for rendering. The image creation section 66 also acquires ball shape data for rendering. In this manner, the competitor's character and ball are displayed in a game image.

In the present embodiment, a shot and trajectory provided by the competitor's character are not computed by acquiring information on an input instruction entered at the competitor's game apparatus 16; instead information required for rendering is acquired only to carry out rendering. Thus, even in the presence of multiple players competing against one another at the same time, it is possible to prevent an increase in processing load and implement real-time display in a game image. In case of a delay in communication, such data as required to compute the trajectory of a ball in conjunction with, for example, a velocity vector may be transmitted and received between the game apparatuses 16.

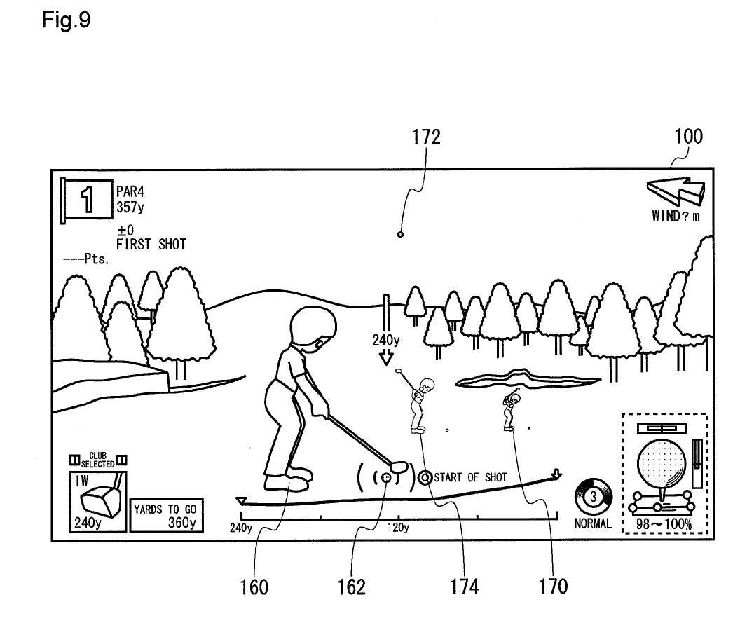

FIG. 9 shows an example of a game image in which a competitor's character and ball are displayed. The game image 100 displays a competitor's character 170 and ball 172 in addition to a character 160 and a ball 162 of a player's own device. This allows the player to progress through a game while checking the status of the competitor. A character 174 present in the direction in which the player's character hits a ball is displayed in a translucent manner. In this manner, the player can provide control without being disturbed. As described above, games such as a golf game are not necessarily required to display the status of a competitor. Thus, when a character or an object is to be displayed in an awkward position, a higher priority is placed on the controllability by the player, so that the character or object is not displayed at all or is displayed in a translucent manner. It is thus possible to improve the controllability by the player while providing a feeling that the player is competing against a competitor.

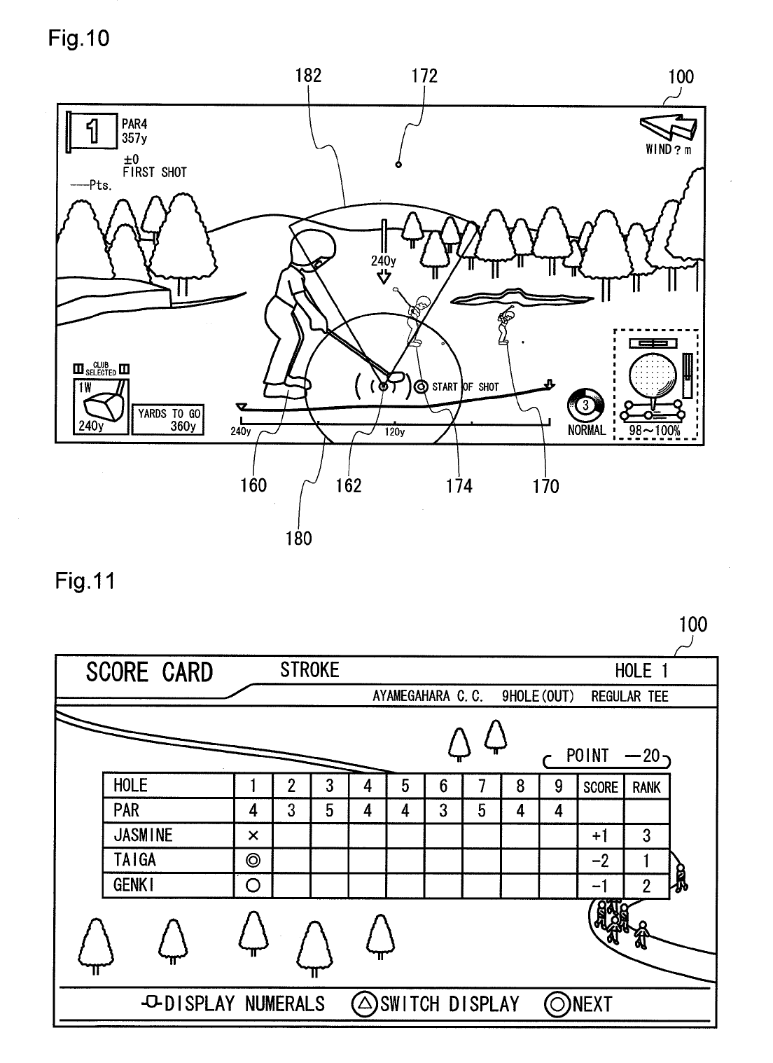

FIG. 10 is an explanatory view illustrating how a determination is made as to whether the competitor's character and ball are displayed. The competitor display section 48 causes the competitor's character and ball present inside a circle 180 having a predetermined radius around a ball 162 of the own device to be not displayed at all, or to be displayed in a translucent manner. Furthermore, the competitor display section 48 causes the competitor's character and ball present inside a sector 182 extending about the ball 162 in the direction of the shot to be not displayed at all, or to be displayed in a translucent manner. The competitor display section 48 may also cause the competitor's character and ball present around the orbit of a swing made by a character 160 of the own device to be not displayed at all, or to be displayed in a translucent manner.

FIG. 11 shows an example of a score display image appearing upon completion of a hole. When the player has completed a hole, the score management section 51 informs the management server 14 of his/her score. The tournament management section 94 updates the management table 82 based on the score informed, while the ranking management section 95 updates the rankings. The data transmit section 93 transmits the score and ranking of each player to the game apparatus 16 for the players who have completed the hole. The score management section 51 of the game apparatus 16 displays the acquired competitors' score and ranking in the game image 100. Even after the player has completed a hole, the display image may display the hole again, so that the player can watch the play of a competitor who has not yet completed the hole.

In the foregoing, the present invention has been described in accordance with an embodiment. The embodiment was provided by way of example only. It should thus be understood by those skilled in the art that various modifications may be made to each component thereof and/or to a combination of each of the process steps, and those modified examples also fall within the scope of the present invention.

The technique described in accordance with the embodiment is applicable not only to golf but also to games such as racing or bowling games in which one player can play independently, or where multiple players can play to compete against one another without always having to display the status of a competitor in real time.

In the embodiment, data related to the status of players playing the same game is transmitted and received between the players via a management server. However, the data may be transmitted and received not via the management server but rather directly between the game apparatuses. Furthermore, the present invention is also applicable to a case where one game apparatus is used for a plurality of players in order to compete against one another with the screen divided in order to display multiple game images, there being one each player.

What is claimed is:

1. A game control program product, comprising:
a controlling module which receives an input instruction from a player to control a character or an object;
a generating and displaying module which generates and displays a game image which includes the character or object;
an acquiring module which acquires information about a character or an object being controlled by another player; and
the displaying module which displays the character or object being controlled by the other player in the game image, wherein
when a position of the character or object being controlled by the other player meets a predetermined condition that the player's progression through the game is interrupted by the character or object controlled by the other player being displayed in the game image, the displaying module causes the character or object being controlled by the other player to be not displayed at all, or to be displayed with increased transparency.

2. The game control program product according to claim 1, wherein the predetermined condition includes at least one of the following conditions regarding where the character or object being controlled by the other player is located;
within a predetermined range from a view point position at which the game image is created,
within a predetermined range from the character or object being controlled by the player,
in between the view point position and the character or object,
within a predetermined range from a target position to which the player is trying to move the character or object,
in between the target position and the character or object, and
in a direction in which the character or object moves.

3. The game control program product according to claim 1, wherein the controlling module controls a motion or a movement of the character or object irrespective of the character or object being controlled by the other player.

4. The game control program product according to claim 1, wherein the acquiring module acquires information about the character or object being controlled by the other player in another game apparatus from a management server which manages a plurality of game apparatuses which are running a game at the same time, and
the game control program product further comprises a transmitting module which transmits information about the character or object controlled by the controlling module to the management server.

5. The game control program product according to claim 1, wherein the acquiring module acquires information that is indicative of a position of the character or object being controlled by the other player, and
the displaying module waits until the acquiring module acquires information, the information indicating the position of the character or object for a predetermined number of game image frames, and then based on the information that is indicative of the position, displays the character or object being controlled by the other player in the game image.

6. The game control program product according to claim 1, wherein the controlling module controls a golf game played by a character controlled by the player, defines a time limit from a start of a play of a hole until the character completes the hole, and terminates the game if the character cannot complete the hole within the time limit.

7. The game control program product according to claim 6, wherein the controlling module gives a benefit to a player if the player completes a hole earlier than any other player.

8. A game apparatus, comprising:
a controlling section which receives an input instruction from a player to control a character or an object;
an acquiring section which acquires information about a character or an object being controlled by another player; and
a displaying section which generates and displays a game image which includes the character or object, and the character or object being controlled by the other player, wherein
when a position of the character or object being controlled by the other player meets a predetermined condition such that the player's progression through a game is interrupted by the character or object controlled by the other player being displayed in the game image, the displaying section causes the character or object being controlled by the other player to be not displayed at all, or to be displayed with increased transparency.

9. A game control method, comprising:
receiving an input instruction from a player to control a character or an object;
generating and displaying a game image which includes the character or object;
acquiring information about a character or an object being controlled by another player; and
displaying the character or object being controlled by the other player in the game image, wherein
when a position of the character or object being controlled by the other player meets a predetermined condition that the player's progression through a game is interrupted by the character or object controlled by the other player being displayed in the game image, the character or object being controlled by the other player is caused to be not displayed at all, or to be displayed with increased transparency.

10. A computer readable recording medium, in which the game control program according to claim 1 is recorded.

11. A management server, comprising:
a participant registration section which registers a plurality of game apparatuses running a game and participating in a tournament in which the game apparatuses play the game in parallel in order to compete against one another;
a data receive section which receives, from a game apparatus participating in the tournament, information that is indicative of a position of a character or an object in the game that is being played by the game apparatus; and
a data transmit section which transmits the information received from the game apparatus to another game apparatus that meets a predetermined condition from among the plurality of game apparatuses participating in the same tournament.

12. The management server according to claim 11, further comprising a management section which manages a ranking in the tournament, wherein
the data transmit section transmits the information to a game apparatus of a player having a ranking higher or close to that of a receiving game apparatus, or to a game apparatus of a player that the player of the receiving game apparatus has registered in advance.
